(19) United States
(12) Patent Application Publication
(10) Pub. No.: US 2026/0260361 A1
(43) Pub. Date: Sep. 3, 2026

(54) METHOD FOR AUTOMATICALLY DETECTING A BIOLOGICAL ELEMENT IN A TISSUE SAMPLE

(71) Applicant: QUANTMETRY, Paris (FR)

(72) Inventors: Damien HERVAULT, Paris (FR); Hugo SEVILLIA, Paris (FR); Vincent BLOT, Montrouge (FR); Alexandra LORENZO, Rueil-Malmaison (FR); Nicolas BRUNEL, Antony (FR); Céline LABEYRIE, Paris (FR); Olivier TRASSARD, Montigny les Cormeilles (FR); David ADAMS, Levallois Perret (FR); Clovis ADAM, Le Kremlin-Bicêtre (FR)

(21) Appl. No.: 18/832,388

(22) PCT Filed: Jan. 17, 2023
(86) PCT No.: PCT/FR2023/050060

§ 371 Date: Jul. 23, 2024

(30) Foreign Application Priority Data
Jan. 24, 2022 (FR) FR2200588

(51) Int. Cl. G06T 7/13; G06T 7/174

(52) U.S. Cl. CPC G06T 7/13; G06T 7/174; G06T 2207/20081; G06T 2207/20084; G06T 2207/30088

(57) ABSTRACT

A method for automatically detecting a predetermined biological element in a human or animal tissue sample includes feeding (12) at least one artificial neural network with a plurality of machine-learning images of the biological sample; processing an image of the tissue sample such as to extract (22) therefrom regions of interest in which the biological element is to be detected; and subdividing (24) each region of interest into a plurality of patches. In each patch, the at least one artificial neural network is used to automatically obtain (26) a prediction for the detection of the biological element; and (28) the image of the tissue sample is reconstructing from the individual, having the detection predictions of the biological element.

The present invention relates to a method for automated detection of a predetermined biological element in a tissue sample taken from a human or animal.

The invention relates to the medical field. It is in particular, but not only, applicable in the field of determining the density of intra-epidermal nerve fibers.

Small fiber neuropathy (SFN) is characterized by sensory symptoms in the lower extremities, pain, and a quantitative deficit of small nerve fibers.

Skin biopsy with evaluation of intra-epidermal nerve fiber density (IENFD) is currently considered to be the best technique allowing a practitioner to diagnose SFN.

Nevertheless, this technique involves counting intra-epidermal nerve fibers manually, this being very time-consuming including for an experienced operator and further leading to a high variability in the results, and to errors.

More generally, when it comes to detecting a predetermined biological element in a tissue sample, there is a need for the detection technique to be fast, reproducible, robust and reliable.

The aim of the present invention is to remedy the aforementioned drawbacks of the prior art.

To this end, the present invention provides a method for automated detection of a predetermined biological element in a tissue sample of a human or animal, noteworthy in that it comprises steps of:
obtaining a plurality of machine-learning images of the biological element, from a plurality of tissue samples of at least one subject;
feeding at least one artificial neural network with the plurality of machine-learning images;
obtaining a stack of images, in a plurality of parallel planes, of the tissue sample of the human or animal;
concatenating the images of the stack into a single image;
performing automatic edge detection on the single image, and applying the detected edges to each image of the stack;
extracting from each image of the stack a region of interest, where the biological element is to be detected;
subdividing each region of interest into a plurality of patches;
in each patch, using the at least one artificial neural network, automatically obtaining a detection prediction for the biological element;
combining each plurality of patches comprising the detection predictions into an image of each region of interest, then stacking the images of each region of interest, so as to obtain a reconstructed image of the tissue sample of the human or animal comprising the detection predictions of the biological element.

The main advantage of the method according to the invention is that it is automatic. Automatic detection has proven to be highly accurate and to achieve significant time savings compared to current manual techniques. Furthermore, the successive steps of image decomposition and analysis implemented by the method according to the invention have the originality of allowing detection of biological elements of a size much smaller than those capable of being detected using conventional image-processing techniques.

In one particular embodiment, the step of obtaining a stack of images, in a plurality of parallel planes, of the tissue sample of the human or animal comprises using an immunofluorescence scanner.

This type of apparatus allows stacks of images in several tens of planes to be obtained in a simple and direct way.

In one particular embodiment, the step of automatic edge detection comprises steps of blurring, and of image dilation and erosion.

The signal processing conventional in computer vision including blurring, dilation and erosion allows local artefacts typically present in medical imaging to be attenuated.

In one particular embodiment, the step of extracting the region of interest implements a semantic-segmentation algorithm, i.e. detection by pixel of the region of interest.

In one particular embodiment, each detection prediction is represented by a bounding box that is the smallest rectangle containing the image of the biological element detection of which is predicted.

In one particular embodiment, the step of automatically obtaining the detection prediction using the at least one artificial neural network comprises a step of computing posterior probability for some images.

In this embodiment, according to one possible particular feature, the step of computing posterior probability for some images implements a Kalman filter, to compensate for noisy measurements, this often being the case with medical imaging.

This allows the results of the semantic segmentation to be smoothed and improved.

In one particular embodiment, the tissue is the skin and the biological element is an intra-epidermal nerve fiber.

Specifically, the invention is particularly advantageously applicable to automatic detection of intra-epidermal nerve fibers in the context of small-nerve-fiber research.

### BRIEF DESCRIPTION OF THE DRAWINGS

Other aspects and advantages of the invention will become apparent on reading the detailed description below of particular embodiments, which are given by way of entirely non-limiting examples, with reference to the appended drawings, in which:

FIG. 1 is a flowchart illustrating the main steps of a method according to the present invention, in one particular embodiment.

FIG. 2 is a flowchart illustrating use of a Kalman filter applied to some images, in one particular embodiment of the method according to the present invention.

### DESCRIPTION OF ONE OR MORE EMBODIMENTS

The method according to the invention implements an artificial neural network. It is therefore necessary to provide machine-learning data to this artificial neural network in order for it to be able to function.

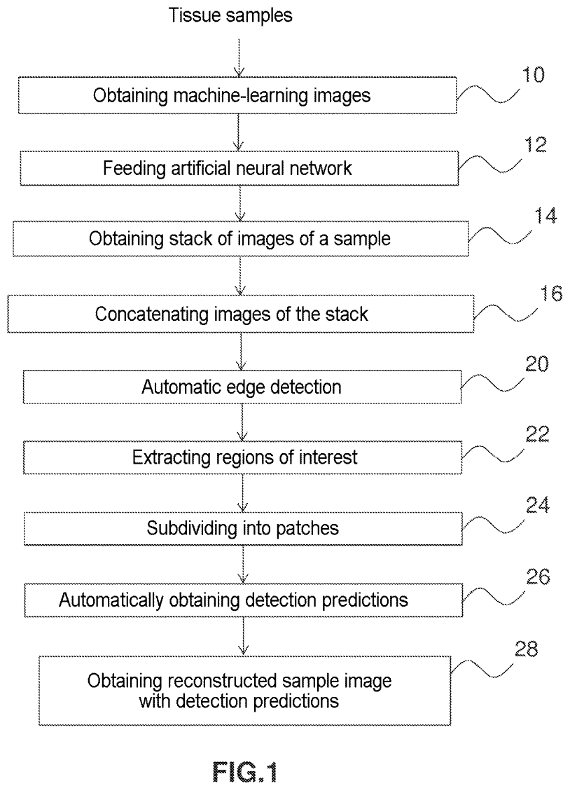

Thus, as shown in the flowchart of FIG. 1, in one particular embodiment, a method according to the present invention, for automated detection of a predetermined biological element in a tissue sample of a human or animal, comprises a first step 10 of obtaining a plurality of machine-learning images of the biological element, from a plurality of biological tissue samples of one or more subjects.

By way of non-limiting example, the invention will be described in the context of application thereof to automated detection of intra-epidermal nerve fibers.

In this example, the tissue in question is the skin and the biological element in question is a nerve fiber.

The plurality of tissue samples is typically obtained by sampling from one or more subjects. In the non-limiting example described here, the tissue samples may be obtained through skin biopsy at one or more locations, for example on the ankle, thigh and/or wrist, if the subject is a human.

The machine-learning images are for example obtained by means of a medical imaging apparatus such as an immunofluorescence scanner. They are labeled so as to identify therein the biological element and optionally a certain number of other constituent elements, or biomarkers, of the tissue samples. In the non-limiting example described here, elements such as the basement membrane, small nerve fibers, the dermis and nerve fibers passing through the dermal-epidermal junction are identified in each image.

In a following step 12 of the method according to the invention, these machine-learning images are fed as input into one or more artificial neural networks. Various neural networks may be used and advantageously multiple versions of each machine-learning method are used. Various labels may be applied to the training data depending on the selected neural-network model and, for each model, various inputs, various data representations and/or various learning parameters may be used.

Next, in a step 14, a tissue sample of a specific human or animal, where the predetermined biological element is to be detected, is considered. By means of the same medical-imaging apparatus, for example an immunofluorescence scanner, a stack of images of the tissue sample of this human or animal is obtained, in a plurality of parallel planes, for example 20 planes. In one particular embodiment, grayscale images may be obtained. As a variant, color images may be obtained. In this case, it is possible to make provision to obtain a plurality of stacks of images, including one per channel of different color, each of these channels allowing detection of one different constituent element, or biomarker, of the tissue sample. By way of non-limiting example, the various channels may for example be a green channel and a red channel.

In the non-limiting example described here, the green and red channels allow detection of biomarkers to be improved. The green channel facilitates detection of the epidermis-dermis region, while the red channel improves detection of nerve fibers. Generally, the use of multiple colors improves the robustness of detection algorithms in medical imaging, but remains optional.

At this stage of the method, the images, which are so-called whole-slide immunofluorescence images, are very large and cannot be exploited given the small size of the biological element to be detected. For this reason, next, in a step 16, the images of the stack are concatenated into a single image. In the case where there is a plurality of channels, the images of each stack are concatenated, then all the images thus concatenated are concatenated into a single image. This single image is obtained in order to automatically identify sections in the whole-slide images, the objective being to create a large mesh model in order to quickly detect therein slices cut from the tissue sample, a given slide being liable to contain a number of slices.

The following step 20 consists in automatically detecting edges in this single image. To this end, the image may optionally be resized, for example by a factor of 0.1, this allowing computer-vision techniques to be applied. This step 20 of automatic edge detection may comprise steps of blurring to attenuate local artefacts, of image dilation and of image erosion involving thresholding in order to remove noise. The automatic edge detection may for example implement an algorithm of the type available in the OpenCV graphics library.

Once edges have been detected in the resized image, the detected edges may be enlarged and applied to each concatenated image (for each of the aforementioned channels if there are a plurality of channels), and then to each image of the stack (for each of the channels if there are a plurality of channels).

Since the images are still too large to allow the sought biological element to be detected therein, the following step 22 consists in extracting from each image of the stack (for each of the channels if there are a plurality of channels) a region of interest, in which the biological element is to be detected. In the non-limiting example described here, the region of interest represents the intra-epidermal region, where the analysis of the nerve fibers must be performed. To speed up the process of detecting the region of interest, images with a size of 256×256 pixels may for example be used.

The step 22 of extracting the region of interest may for example implement a semantic-segmentation algorithm, and the result of this segmentation may be enlarged before proceeding with the analysis of the region of interest.

For the purposes of this analysis, in the following step 24, each region of interest is subdivided into a plurality of patches.

In the following step 26, in each patch, using the one or more artificial neural networks, a detection prediction of the predetermined biological element, i.e. a nerve-fiber detection prediction in the non-limiting example described here, is automatically obtained.

In the non-limiting example described here, to speed up this process, three semantic-segmentation algorithms known per se are applied in parallel, to segment nerve fibers, to segment the basement membrane and to segment the dermis area, respectively. In order to improve the robustness and reproducibility of the prediction, data-augmenting techniques, known per se, may be used to enrich the data set, by randomly creating images having undergone for example partial cropping and/or a rotation and/or color modification.

In one particular embodiment, it is possible to take advantage of the particular properties of a constituent element, or biomarker, of the studied tissue to apply thereto, during step 26 of obtaining detection predictions, a posterior-probability computation. In the non-limiting example described here, the basement membrane generally has the property of being a continuous line in each plane among the parallel planes of the stack. It is advantageous to carry out a step of posterior-probability computation on the results of segmentation of the basement membrane as it makes it possible to greatly reduce noise in an image. Applying a Kalman filter to the images, as may be done in one particular embodiment of the method according to the present invention, is in this regard novel. Alternatively to a Kalman filter, the method may include any other process allowing the data to be denoised.

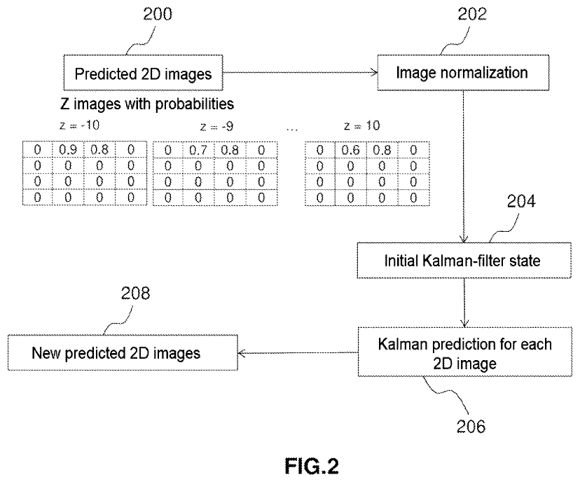

As shown in FIG. 2, this optional step of computing posterior probability may for example implement a Kalman filter. To this end, all the prediction results obtained for the basement membrane are used, on the two-dimensional images in all the parallel planes of the stack (it is assumed in the drawing by way of non-limiting example that there are Z planes designated by z=−10, z=−9, . . . , z=−1, z=1, . . . , z=9, z=10). These prediction results are concatenated (the “predicted 2D images” 200 in the drawing) so as to obtain a three-dimensional image, for example one that is 512×512×20 pixels in size, and three-dimensional patches having a specific kernel size are created in this image by normalizing the images in a step 202 (for example using a logistic function to transform the images) and a Kalman filter is applied to each three-dimensional patch. The size of each three-dimensional patch is selected so as to be congruent with the computational cost of the Kalman filter and in light of the fact that only nearest-neighbor pixels will be required to reconstruct the image of the basement membrane.

In step 204, the initial state of the Kalman filter is selected not randomly, but rather using the mean of the predictions of each three-dimensional patch along the axis of the stack. In other words, two-dimensional images corresponding to the various layers of the stack are processed. After application of the Kalman filter to each patch in a step 206, new prediction results are obtained (the “new predicted 2D images” 208 in the drawing) and the three-dimensional image is reconstructed with an updated and therefore improved prediction for each three-dimensional patch in its nearest plane in the stack, i.e. the prediction state of a layer of the stack is used to predict the prediction state of the nearest layer.

In the non-limiting example described here, from the prediction of detection of the basement membrane, it is possible to obtain a detection of the dermis, by combining the prediction of detection of the basement membrane with computer-vision techniques that are known per se.

At the end of the step 26 of automatically obtaining detection predictions, a step 28 of the method according to the invention is carried out, in which step each plurality of patches comprising the detection predictions is combined into an image of each region of interest, then the images of each region of interest are stacked, so as to obtain a reconstructed image of the tissue sample of the examined human or animal, comprising the detection predictions of the predetermined biological element, i.e. the nerve fibers in the non-limiting example described here.

In the non-limiting example described here, the detection predictions resulting from semantic segmentation of nerve fibers, of the basement membrane, and of the dermis are combined into a single image, where one different color channel represents the prediction of each of these constituent elements, or biomarkers, of the sample: for example, a red channel represents the prediction of nerve fibers, a green channel represents the prediction of the basement membrane, and a blue channel represents the prediction of the dermis.

In one particular embodiment, each detection prediction of the predetermined biological element is represented by a bounding box, which is the smallest rectangle containing the image of the biological element detection of which is predicted.

At the start of step 28 of obtaining a reconstructed image of the sample comprising the detection predictions, the bounding boxes are present in the two-dimensional patches of the stacks in the plurality of parallel planes. Next, all the patches are combined, i.e. all the predictions expressed by the bounding boxes are stacked, in order to recreate a slice of the tissue sample. For each prediction, i.e. for each bounding box, the pairwise distance, i.e. the distance between the bounding boxes considered two by two, is then computed. A matrix of the pairwise distances is thus obtained. By considering the stack of bounding boxes, the three-dimensional intersection corresponding to intersection of the bounding boxes over the entire stack is thus obtained.

It may for example be decided that the nearer two bounding boxes are to each other, the closer their pairwise distance gets to 1 and that, conversely, a value close to 0 means that the two bounding boxes of the pair in question are not near to each other at all. Using unsupervised learning techniques and clustering techniques, bounding boxes that it has been computed are near each other may then be clustered and thus a map of the tissue sample in which each occurrence of the predetermined biological element is localized may be obtained, in accordance with the obtained detection predictions.

1. A method for automated detection of a predetermined biological element in a tissue sample of a human or animal, said method comprising the steps of:
obtaining a plurality of machine-learning images of said biological element, from a plurality of tissue samples of at least one subject;
feeding at least one artificial neural network with said plurality of machine-learning images;
obtaining a stack of images, in a plurality of parallel planes, of said tissue sample of said human or animal;
concatenating the images of said stack into a single image;
performing automatic edge detection on said single image, and applying the detected edges to each image of said stack for each of said channels;
extracting from each image of said stack a region of interest, where said biological element is to be detected;
subdividing each region of interest into a plurality of patches;
in each patch, using said at least one artificial neural network, automatically obtaining a detection prediction for said biological element;
combining each plurality of patches comprising said detection predictions into an image of each region of interest, then stacking the images of each region of interest, so as to obtain
a reconstructed image of said tissue sample of said human or animal comprising said detection predictions of said biological element.

2. The method as claimed in claim 1, wherein the step of obtaining a stack of images, in a plurality of parallel planes, of said tissue sample of said human or animal comprises using an immunofluorescence scanner.

3. The method as claimed in claim 1, wherein the step of automatic edge detection comprises steps of blurring, and of image dilation and erosion.

4. The method as claimed in claim 1, wherein the step of extracting said region of interest implements a semantic-segmentation algorithm.

5. The method as claimed in claim 1, wherein each detection prediction is represented by a bounding box that is the smallest rectangle containing the image of said biological element detection of which is predicted.

6. The method as claimed in claim 1, wherein the step of automatically obtaining said detection prediction using said at least one artificial neural network comprises a step of computing posterior probability for some images.

7. The method as claimed in claim 6, wherein said step of computing posterior probability for some images implements a Kalman filter.

8. The method as claimed in claim 1, wherein said tissue is the skin and said biological element is an intra-epidermal nerve fiber.
